(19) United States
(12) Patent Application Publication
(10) Pub. No.: US 2008/0219623 A1
(43) Pub. Date: Sep. 11, 2008

(54) Star coupler for optical networks, in particular for optical data buses in motor vehicles

(75) Inventors: Werner Sklarek, Heidesheim (DE); Burkhard Danielzik, Bingen (DE); Thomas Henrich, Steinbach (DE)

Correspondence Address: DeMont & Breyer, LLC, 100 Commons Way, Ste. 250, Holmdel, NJ, 07733, US

(73) Assignee: SCHOTT AG, Mainz (DE)

(21) Appl. No.: 11/932,655

(22) Filed: Oct. 31, 2007

(30) Foreign Application Priority Data
Nov. 3, 2006 (DE) 10 2006 052 255.9

(51) Int. Cl. G02B 6/26

(52) U.S. Cl. 385/46

(57) ABSTRACT

In order to achieve an increased reliability in respect of failure in optical networks, the invention provides a passive star coupler comprising a multiplicity of at least three optical waveguides as arms of the star coupler, which are combined at one end, and comprising, adjacent to the combined end, a reflective light mixer in the form of a common individual optical waveguide section with a light reflector, which reflects light which is guided through one of the optical waveguides and passes through the adjacent common individual optical waveguide section back into the common individual optical waveguide section, such that the light is split between the individual optical waveguides and is forwarded through the latter.

The invention generally relates to optical networks; in particular, the invention relates to a passive star coupler for such networks.

Optical data transmission is becoming more and more important in modern motor vehicles. Thus, safety-relevant systems such as airbags are in many cases controlled via a so-called byteflight bus. The byteflight bus system is based on a network in star topology with an intelligent star coupler. These networks are currently operated with transmission rates of 10 Mbit/s. The data transmission process is message-oriented, similarly to a CAN bus. All signals are made available to all connected stations. In addition, a real-time capability is achieved according to the TDMA principle.

In “Drive by Wire” applications, consideration is also given to a so-called Flexray bus. Flexray is a serial, fault-tolerant bus system for motor vehicles which uses a TTP/C-like protocol with a temporal synchronization, likewise according to the TDMA principle, in order to meet hard real-time requirements.

One of the essential differences in optical networks in motor vehicles compared with other fiber-optic communication networks consists, in particular, in the harsh environment. Fibers and connectors are exposed to high temperatures, high temperature fluctuations and vibrations in a motor vehicle. Thus, a continuous thermal stability up to a temperature of 125° C. is generally demanded of the electronic components used in the motor vehicle sector.

In the optical networks used in motor vehicles, signals often have to be passed from one line to a multiplicity of further lines. Active star couplers have hitherto been provided for this purpose. In the case of said star couplers, an E/O transducer (electro-optical transducer) is provided in each arm of the coupler. However, with the failure of just one of the transducers, such a star coupler already constitutes a fault source that can lead to unforeseen failures of different functions of the motor vehicle. This is already undesirable in particular if it is taken into consideration that faults in the vehicle electronics have now become the most common cause of breakdowns. Therefore, precisely in this field there is a need to make the electronic systems as robust and fail-safe as possible.

Therefore, the invention is based on the object of providing a particularly disturbance-immune star coupler, in particular for optical networks, in particular in vehicles.

This object is already achieved in an extremely surprisingly simple manner by means of the subject matter of the independent claims. Advantageous configurations and developments of the invention are specified in the subclaims.

Accordingly, the invention provides a passive star coupler comprising a multiplicity of at least three optical waveguides as arms of the star coupler, which are combined at one end, and comprising, adjacent to the combined end, a reflective light mixer in the form of a common individual optical waveguide section with a light reflector, which reflects light which is guided through one of the optical waveguides and passes through the adjacent common individual optical waveguide section back into the common individual optical waveguide section, such that the light is split between the individual optical waveguides and is forwarded through the latter. What is achieved by means of the light mixer is that the incoming signal power is split between the individual optical waveguides as uniformly as possible after reflection. Preferably, the length and thickness of the optical waveguide section are dimensioned for this purpose such that the signal powers of signals reflected back in the individual optical waveguides vary by at most 15%.

The invention provides a fully passively operating star coupler, such that failures in the electronics of previously used active star couplers with electro-optical transducers in all the arms are avoided and an increased reliability in respect of a failure is thus obtained. The invention is particularly advantageous for relatively small networks, such as optical motor vehicle bus systems, for instance.

In particular, the advantages of the invention are also manifested in the case of bus systems which have a star topology and use a passive central distributor with a star coupler according to the invention. Such star topologies are precisely also suitable for optical motor vehicle bus systems. Star topologies are already inherently distinguished by a high reliability in respect of failure since, upon failure of one of the connected components, the whole network or the communication of the further components is not influenced. On the other hand, a total failure occurs if the central distributor fails. Here the invention can precisely provide an increased reliability in respect of failure, however, since failure of the electronics of a central distributor is precluded on account of the passive design.

Since the star coupler according to the invention offers a high degree of reliability in respect of failure, it is also predestined for other, safety-critical applications. Consideration is given here also to use in optical bus systems of aircraft, inter alia.

The individual optical waveguide section serving as light mixer is preferably formed as a clad core rod, in which the cladding has a lower refractive index than the core. It is furthermore preferred to use a reflective light mixer with an individual optical waveguide section which comprises a reflective end. Said end can be reflectively coated, in particular.

As an alternative or in addition, totally reflective surfaces can also be provided at the end of the optical waveguide section, such that a back reflection is effected by total reflection of the light guided through the light mixer. By way of example, for this purpose it is possible to provide a prism or cone at the end of the light mixer.

However, it is also conceivable to use an optical waveguide shaped to form an optical loop as light reflector. Such a loop constitutes an optical waveguide section which is spliced back into itself and which is adjacent to the individual optical waveguide section, or in which the splice forms the individual optical waveguide section. In this embodiment, light mixing also takes place along the optical loop.

The invention is particular suitable for networks with multimode fibers as signal lines. Accordingly, optical waveguides combined at one end which are in the form of multimode fibers are preferably used for the star coupler. Monomode fibers generally have a fiber core surrounded by a comparatively significantly thicker cladding. Without further measures, this leads to high coupling losses in the star coupler since the majority of the light reflected back would be coupled into the claddings, instead of into the fiber cores.

In this case, the multimode fibers preferably used can comprise, in particular, optical waveguides combined at one end which are in the form of thick-core fibers. In order to minimize the coupling losses, thick-core fibers having a ratio of the thicknesses of core and cladding of at least 9/1 are furthermore preferably used for this purpose. The light-guiding region of the thick-core fibers preferably has a core diameter of at least 0.2 millimeter.

The light mixer acts, in particular, by reflection of the light guided through the individual optical waveguide section at the walls thereof. Both the spatial intensity distribution and the angular distribution of the light are homogenized in this case. One aim in this case is to achieve an intensity field that is as homogeneous as possible at the combined ends of the optical waveguides for the light that is guided through the individual optical waveguide, reflected and guided back again.

In order to obtain the best possible light mixing, it is favorable if the diameter and length of the individual optical waveguide section are dimensioned such that the light transmitted through the individual optical waveguide section from one of the optical waveguides is reflected at least on average 1.5 times, preferably at least on average 2.0 times, particularly preferably at least on average 2.5 times, in the individual optical waveguide section at the wall thereof along the optical path including the back reflection at the light reflector. Such a property of the light mixer can be achieved in particular when the product of numerical aperture and the ratio of length L to diameter d of the individual optical waveguide section, NA·d/L, is at least 5, preferably at least 6, particularly preferably at least 8.

In order to combine the optical waveguides at one end, the optical waveguides can be adhesively bonded or fused together at their combined ends.

The individual optical waveguide section can preferably be placed as a separate part, in particular in the form of a core-cladding rod onto the combined ends of the optical waveguides. However, it is also conceivable to use the combined section of the ends of the optical waveguides itself as part of the light mixer. For this purpose, for instance, the cladding material could be removed and the cores could be fused together or be adhesively bonded with an adhesive bond having an identical or similar refractive index. Placing on a separate light-guiding rod is structurally simpler to realize, however.

In order to realize flexible optical waveguides which can be laid easily, instead of individual optical waveguides it is also possible to use optical waveguide bundles as optical waveguides.

The non-combined ends of the optical waveguides of the star coupler can be provided with suitable plug connectors in order to connect them for example to further fibers of the network. An embodiment as a small rigid component is also possible. Such an embodiment is also referred to as a “pigtail” in the field of optical data communications. The optical waveguide ends of the “pigtail” star coupler can be used directly in a suitable connector strip, the fibers of the network being coupled to said connector strip, preferably by means of suitable plug connectors.

If the intention is to avoid the further coupling losses at the plug connectors, in accordance with one development of the invention the star coupler can also have at least one optical waveguide having a length of at least 1 meter. Here consideration is given to dimensioning the length of the optical waveguides such that the components, or at least some components of the network can be connected directly to the star coupler, or the non-combined ends of the optical waveguides. For these components, the optical waveguides of the star coupler can then simultaneously form the optical connections of the network to the respective components.

On account of its passive design, in contrast to active star couplers, the star coupler according to the invention generally has a coupling loss amounting to at least 10*log(n)dB, where n denotes the number of combined optical waveguides. Nevertheless, the attenuation can be limited in many cases to a maximum of 13 dB, in particular on account of a limited number of coupled optical waveguides. It is particularly preferred to use at most 15, preferably at most 10, combined optical waveguides for the star coupler in order to keep the coupling losses low. However, this number is generally entirely sufficient particularly for optical networks in motor vehicles.

The invention is explained in more detail below on the basis of exemplary embodiments and with reference to the accompanying drawings. In this case, identical reference symbols designate identical or similar parts. In the figures:

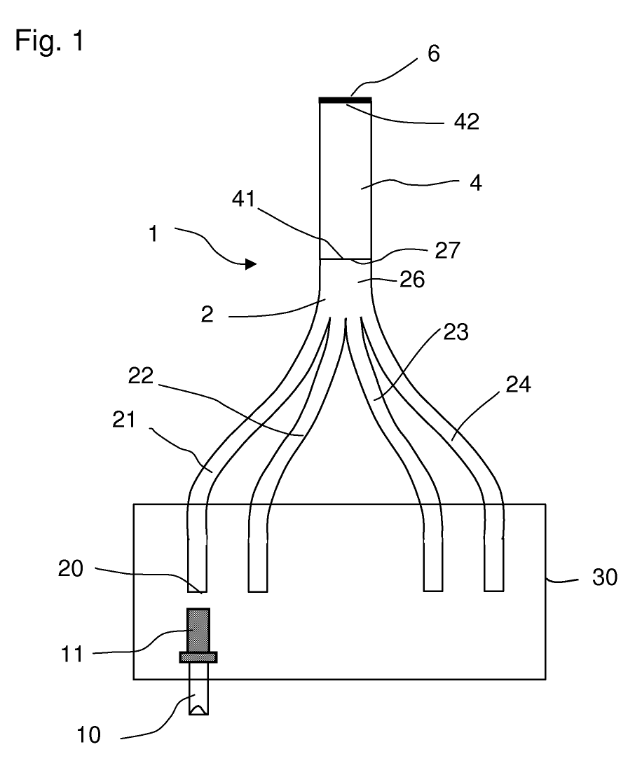

FIG. 1 shows a view of a first exemplary embodiment of a star coupler in the form of a pigtail component,

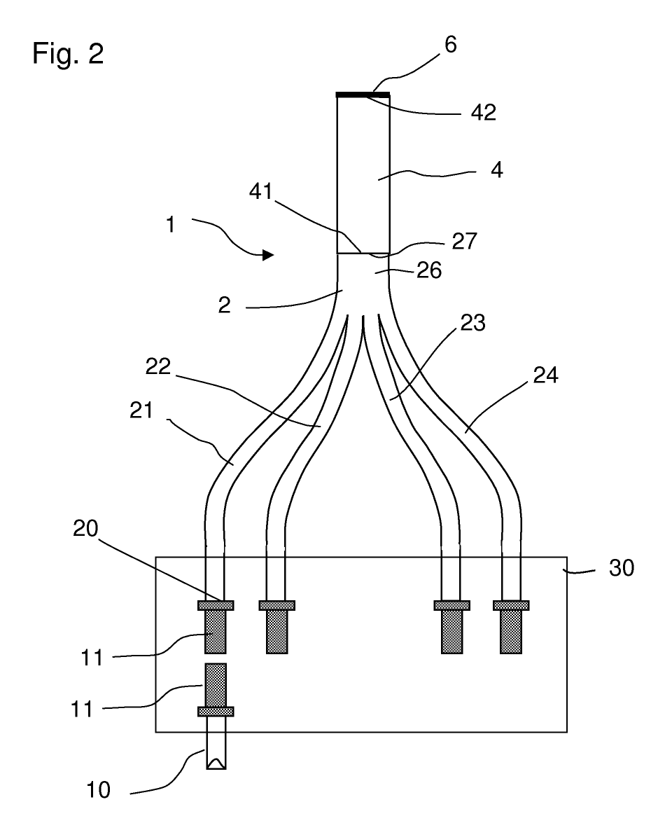

FIG. 2 shows a variant of the exemplary embodiment illustrated in FIG. 1 with flexible optical waveguides,

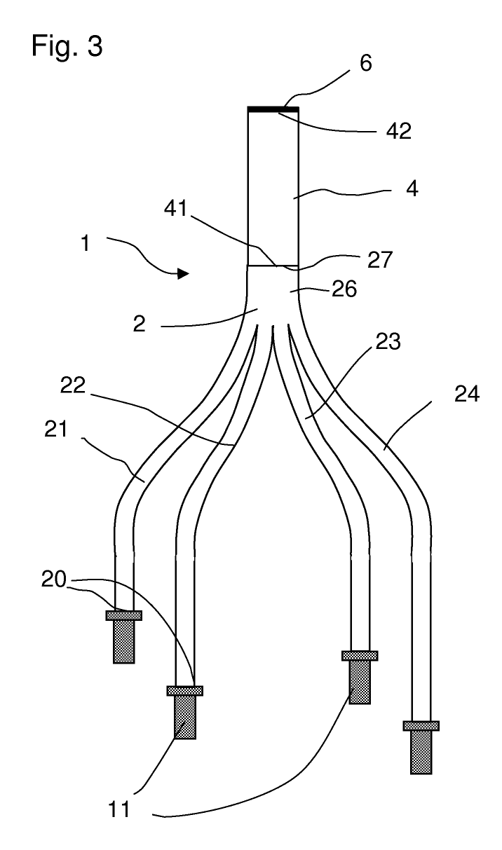

FIG. 3 shows a further variant with long optical waveguides for the direct coupling of network components,

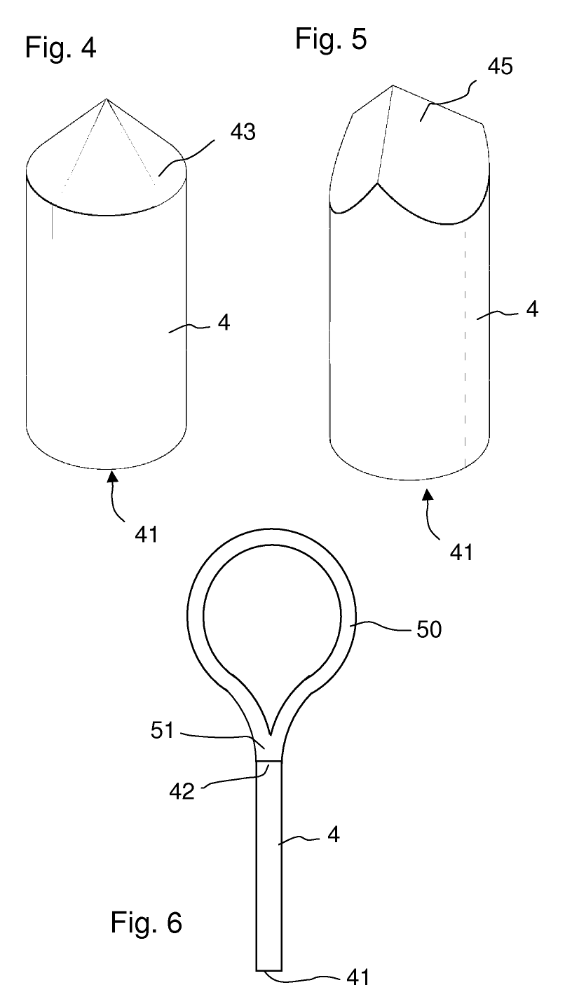

FIGS. 4 to 6 show alternative configurations of the light reflector, and

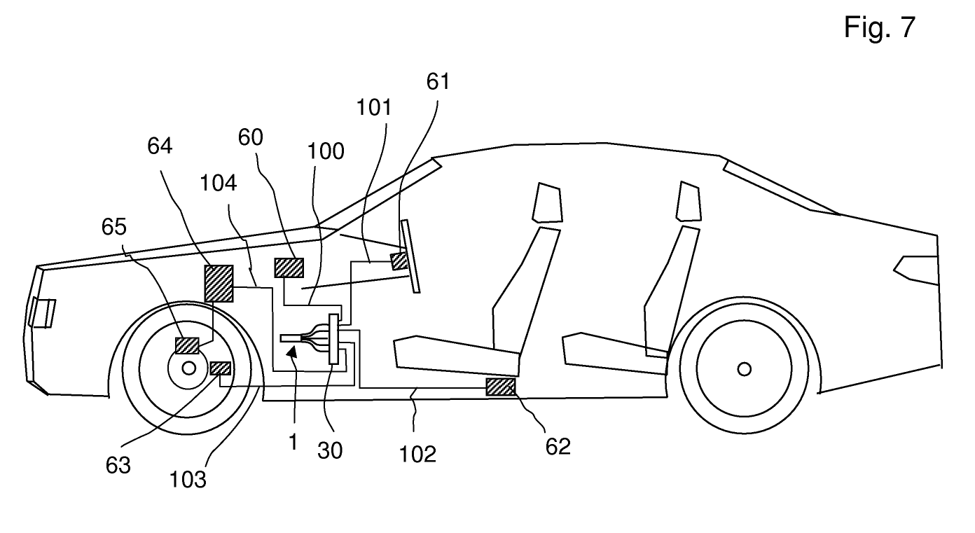

FIG. 7 shows a motor vehicle with an optical bus system comprising a star coupler according to the invention.

FIG. 1 schematically shows a passive star coupler, which is designated as a whole by the reference symbol 1. The star coupler comprises a multiplicity of at least 3 arms, the example shown in FIG. 1 having four arms in the form of optical waveguides 21, 22, 23, 24. The optical waveguides are combined at one end along a section 26 to form a part 2, the section 26 leading into an end surface 27. For this purpose, the optical waveguides 21-24 can be adhesive bonded or fused together, by way of examples. The optical waveguides are in each case core-cladding optical waveguides in which the cladding has a lower refractive index than the core, such that the optical waveguides guide light signals by total reflection at the interface between core and cladding.

There is adjacent to the end surface of the section 26 a light mixer in the form of a core-cladding rod 4, which is placed by one end surface 41 thereof onto the end surface 27 of the section 26 of the part 2 with the combined optical waveguides 21-24. The end surface 42 opposite to the end surface 41 is provided with a reflector 6 in the form of a reflective coating.

Preferably, in the case of a rigid pigtail embodiment of the star coupler 1, the optical waveguides and the core-cladding rod 4 of the light mixer are produced from glass. It is likewise possible, however, to produce the part 2 and/or the light mixer from suitable plastics.

The non-combined ends 20 of the optical waveguides 21-24 of the star coupler 1 embodied as a rigid pigtail element are inserted into a connector strip 30 for coupling to the optical waveguide network. Sockets are provided on the opposite side of the connector strip in order to insert optical data lines 10 of the network, which are provided with corresponding plug connectors 11, and to optically couple them in each case to one of the optical waveguides 21-24.

FIG. 2 shows a variant of the exemplary embodiment of a star coupler 1 that is illustrated in FIG. 1. In this variant, the optical waveguides 21-24 of the part 2 are not rigid, but rather flexible. By way of example, for this purpose the optical waveguides 21-24 can in each case be embodied as fiber bundles with a multiplicity of thin core-cladding glass fibers or else as flexible polymer optical fibers. The fiber ends 20 of the fibers 21-24 are provided with optical standard plug connectors 11 in the same way as the optical waveguides 10 to be coupled. In a connector strip 30, the ends of the data lines 10 and of the part 2 of the star coupler 1 are optically coupled in a manner similar to that in the example shown in FIG. 1.

FIG. 3 shows a further variant of the star coupler 1. In this variant, the non-combined ends 20 of the optical waveguides 21-24 are likewise provided with standard plug connectors 11 as in the example shown in FIG. 2. In contrast to the example shown in FIG. 2, however, this star coupler 1 is not embodied as a pigtail component. Rather, the optical waveguides 21-24 are significantly longer, preferably at least 1 meter in length. In particular, the lengths of the optical waveguides 21-24 are adapted in accordance with a preferred use to the distances of components to be connected in a motor vehicle, such that the components of the network, or the network subscribers and/or the nearest connection nodes can be directly connected with these optical waveguides.

Alternative configurations of a light reflector are described below with reference to FIGS. 4 to 6.

FIG. 4 shows a core-cladding rod 4 as light mixer, in which the end surface of the reflective end is shaped conically. The cone formed in this way has an aperture angle which, in the manner of a conical prism, leads to a total reflection of the light guided through the core-cladding rod 4 at the cone surface 43, such that the light is reflected back at this end of the rod 4.

FIG. 5 shows a variant in which the end of the core-cladding rod is formed as a prism 45. The three prism faces are formed in the manner of a triple mirror or cat's eye, such that a back reflection in the direction toward the end surface 41 coupled to the combined ends of the optical waveguides is likewise obtained by total reflection at the prism faces.

In the example shown in FIG. 6, an optical loop 50 is provided as reflector. The optical loop represents a bent optical waveguide, the ends of which are spliced together in a section 51, such that the light which comes from the optical waveguides and is guided through the core-cladding rod 4 is guided along the optical loop back into the rod 4 again. The light mixer with rod 4 and loop 50 as illustrated in FIG. 4 can for example also be embodied in one part, for instance as a glass or plastic shaped part, such that loop 50 and rod 4 form a structural unit.

FIG. 7 schematically shows a motor vehicle with an optical bus system which comprises a star coupler according to the invention. The optical network has a star topology, the passive star coupler 1 serving as a central distributor for the data of the individual connected components. All the data lines 100, 101, 102, 103, 104 by which the components 60, 61, 62, 63, 64 are connected to the bus system are in this case connected to the star coupler 1 via a connector strip 30. The control of the remaining components and the data acquisition are carried out by means of a central processing unit 60 connected to the star coupler 1 via the data line 100. Said unit can in particular also perform the temporal synchronization for sending the data via the data lines 100, 101, 102, 103, 104.

Specifically, besides the central processing unit 60, there are coupled to the star coupler an airbag 61 by means of the data line 101, a seatbelt pretensioner by means of the data line 102, a wheel rotational speed sensor 63 by means of the data line 103 and a brake force distributor 64 by means of the data line 104. The wheel rotational speed sensor or sensors can be used for example for an ABS system which is regulated via the brake force distributor by means of the processing unit 60 and which acts on the brakes 65 of the motor vehicle. Likewise, in connection with a plurality of wheel rotational speed sensors 63 and the brake force distributor 64, it is possible to realize an electronic stability program regulated by the processing unit 60 via the optical bus system.

It is evident to the person skilled in the art that the invention is not restricted to the exemplary embodiments described above, but rather can be varied in diverse ways. In particular, the individual features of the exemplary embodiments can also be combined with one another.

1. A passive star coupler comprising a multiplicity of at least three optical waveguides as arms of the star coupler, which are combined at one end, and comprising, adjacent to the combined end, a reflective light mixer in the form of a common individual optical waveguide section with a light reflector, which reflects light which is guided through one of the optical waveguides and passes through the adjacent common individual optical waveguide section back into the common individual optical waveguide section, such that the light is split between the individual optical waveguides and is forwarded through the latter.

2. The star coupler as claimed in claim 1, wherein the individual optical waveguide section comprises a clad core rod, in which the cladding has a lower refractive index than the core.

3. The star coupler as claimed in claim 2, featuring a reflective light mixer with an individual optical waveguide section which comprises a reflective end.

4. The star coupler as claimed in claim 3, wherein the end of the individual optical waveguide section is reflectively coated.

5. The star coupler as claimed in claim 2, wherein the reflective end is realized by surfaces that subject the light guided through to total reflection.

6. The star coupler as claimed in claim 1, wherein an optical waveguide shaped to form an optical loop is provided as light reflector.

7. The star coupler as claimed in claim 1, featuring optical waveguides combined at one end which are in the form of multimode fibers.

8. The star coupler as claimed in claim 1, featuring optical waveguides combined at one end which are in the form of thick-core fibers.

9. The star coupler as claimed in claim 8, wherein the thick-core fibers have a ratio of the thicknesses of core and cladding of at least 9/1.

10. The star coupler as claimed in claim 8, wherein the light-guiding region of the thick-core fibers has a core diameter of at least 0.2 millimeter.

11. The star coupler as claimed in claim 1, wherein the diameter and length of the individual optical waveguide section are dimensioned such that the light transmitted through the individual optical waveguide section from one of the optical waveguides is reflected at least on average 1.5 times, in the individual optical waveguide section at the wall thereof along the optical path including the back reflection at the light reflector.

12. The star coupler as claimed in claim 1, wherein the product of numerical aperture and the ratio of length L to diameter d of the individual optical waveguide section, NA·d/L, is at least 5.

13. The star coupler as claimed in claim 1, wherein the optical waveguides are adhesively bonded or fused together at their combined ends.

14. The star coupler as claimed in claim 1, wherein the individual optical waveguide section is placed as a separate part onto the combined ends of the optical waveguides.

15. The star coupler as claimed in claim 1, wherein at least one of the optical waveguides combined at one end is formed as an optical waveguide bundle.

16. The star coupler as claimed in claim 1, wherein the non-combined ends of the optical waveguides are provided with plug connectors.

17. The star coupler as claimed in claim 1, wherein the star coupler is formed as a rigid component.

18. The star coupler as claimed in claim 1, wherein at least one of the optical waveguides has a length of at least 1 meter.

19. The star coupler as claimed in claim 1, wherein the coupling loss in the star coupler is at least 10*log(n)dB, where n denotes the number of combined optical waveguides.

20. The star coupler as claimed in claim 1, wherein the star coupler has an attenuation of at most 13 dB.

21. The star coupler as claimed in claim 1, featuring at most 15 combined optical waveguides.

22. An optical motor vehicle or aircraft bus system comprising a star coupler as claimed in claim 1.

23. The optical motor vehicle or aircraft bus system as claimed in claim 22, featuring a star topology, with a passive central distributor comprising a star coupler as claimed in claim 1.
